(19) United States
(12) Patent Application Publication
(10) Pub. No.: US 2026/0148225 A1
(43) Pub. Date: May 28, 2026

(54) AUTOMATIC CRYPTO WALLET BALANCING FOR CUSTODIAL SYSTEMS

(71) Applicant: eBay Inc., San Jose, CA (US)

(72) Inventors: Liang CHENG, Los Altos, CA (US); James Edward MORGAN, Cheshire (GB)

(21) Appl. No.: 18/959,985

(22) Filed: Nov. 26, 2024

(51) Int. Cl. G06Q 20/36; H04L 9/00

(52) U.S. Cl. CPC G06Q 20/3676; H04L 9/50; H04L 2209/56

(57) ABSTRACT

Some aspects relate to technologies for automatic crypto wallet balancing. The crypto wallet balancing can involve rebalancing a first crypto wallet to reduce its balance. This can include monitoring a total value of the first crypto wallet over a time period, where the first crypto wallet is owned by a first user and associated with a first blockchain account on a first blockchain. A rebalance trigger event is detected based on the total value of the first crypto wallet exceeding a maximum threshold value for a threshold amount of time during the time period. Responsive to the rebalance trigger event, a smart contract on the first blockchain is executed, causing: generation of a transaction block transferring digital assets from the first blockchain account to a second blockchain account associated with a second crypto wallet owned by the first user, and addition of the transaction block to the first blockchain.

### BACKGROUND

In the context of cryptocurrencies, a custodial system is a specialized computer system that securely manages and maintains crypto wallets on behalf of its users. Custodial systems attempt to provide a high level of security to protect against hacking and unauthorized access. Users benefit from the convenience of having their digital assets managed by custodial systems, which can also offer additional features, such as insurance against theft, regulatory compliance, and seamless integration with other services.

### SUMMARY

Some aspects of the present technology relate to, among other things, an automatic crypto wallet balancing system for custodial systems. This system aims to enhance the management of digital assets on blockchains by automatically rebalancing and consolidating crypto wallets based on predefined trigger events. The crypto wallet balancing system can rebalance crypto wallets in response to high balances and can consolidate crypto wallets in response to low balances.

For rebalancing, the system monitors the total value of a target crypto wallet during a time period and detects a rebalance trigger event when the total value of the target crypto wallet exceeds a maximum threshold value for a time duration threshold, which comprises a threshold amount of time over the time period. Responsive to detecting the rebalance trigger event, a smart contract on a blockchain is executed to transfer digital assets from a first account associated with the target crypto wallet to a second account associated with a recipient crypto wallet owned by the same user.

For consolidation, the system monitors the total value of a target crypto wallet during a time period and detects a consolidation trigger event when the total value of the target crypto wallet is below a minimum threshold value for a time duration threshold, which comprises a threshold amount of time over the time period. Responsive to detecting the consolidation trigger event, a smart contract on a blockchain is executed to transfer digital assets to a first account associated with the target crypto wallet from a second account associated with a transferor crypto wallet owned by the same user. Alternatively, digital assets could be transferred from the first account to the second account.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a chart providing an example of a rebalance trigger event and a consolidation trigger event for a crypto wallet in accordance with some implementations of the present disclosure;

FIG. 3 is a block diagram showing an example of rebalancing a single-chain crypto wallet in accordance with some implementations of the present disclosure;

FIG. 4 is a block diagram showing an example of rebalancing a multi-chain crypto wallet in accordance with some implementations of the present disclosure;

FIG. 5 is a flow diagram showing a method for automatic crypto wallet rebalancing in response to a rebalance trigger event in accordance with some implementations of the present disclosure;

FIG. 6 is a flow diagram showing a method for determining whether to use an existing crypto wallet or to generate a new crypto wallet for transferring digital assets in response to detecting a rebalance trigger event in accordance with some implementations of the present disclosure;

FIG. 7 is a flow diagram showing a method for automatic crypto wallet consolidation in response to a consolidation trigger event in accordance with some implementations of the present disclosure; and

FIG. 8 is a block diagram of an exemplary computing environment suitable for use in implementations of the present disclosure.

### DETAILED DESCRIPTION

### Overview

Managing crypto wallets presents several technical challenges, particularly in the realm of security. Although custodial systems offer a degree of protection by managing and maintaining crypto wallets on behalf of users, these systems are not immune to hacking. Crypto wallets on custodial systems can still be compromised, leading to the theft of digital assets. This vulnerability arises because custodial systems, while providing convenience and additional features such as insurance against theft and regulatory compliance, still rely on secure storage of private keys. If these keys are accessed by unauthorized parties, the digital assets can be stolen.

Aspects of the technology described herein provide enhanced security for crypto wallets on custodial systems by introducing an automatic system for balancing crypto wallets. This system aims to improve the management of digital assets on blockchains by automatically rebalancing and consolidating crypto wallets based on predefined trigger events. The system maintains balances of crypto wallets below a maximum threshold, thereby addressing security issues for crypto wallets, as digital assets owned by a user can be distributed across multiple crypto wallets with balances below the maximum threshold. The system automatically rebalances crypto wallets when their balances are too high and consolidates them when their balances are too low, thereby optimizing the distribution of digital assets and enhancing security. As will be described in more detail herein, the automatic crypt wallet balancing can be applied to single-chain crypto wallets, in which all digital assets are on a single blockchain, as well as multi-chain crypto wallets, in which the digital assets are on multiple blockchains.

Rebalancing occurs when the balance of a crypto wallet exceeds a maximum threshold value for a time duration threshold. The system monitors the total value of a target crypto wallet over a time period and detects a rebalance trigger event when the balance exceeds the maximum threshold for a threshold amount of time during the time period. Upon detecting such a rebalance trigger event, a smart contract on a blockchain is executed to transfer digital assets from a blockchain account for the target crypto wallet to a blockchain account of a recipient crypto wallet owned by the same user. This transfer reduces the balance of the target crypto wallet, thereby mitigating the risk associated with holding large amounts of digital assets in a single crypto wallet. The recipient crypto wallet can be an existing crypto wallet when the rebalance trigger event is detected or a new crypto wallet generated in response to detecting the rebalance trigger event.

Consolidation is triggered when the balance of a crypto wallet falls below a minimum threshold value for a time duration threshold. The system monitors the total value of a target crypto wallet over a time period and detects a consolidation trigger event when the balance remains below the minimum threshold for a threshold amount of time during the time period. In response, a smart contract on a blockchain is executed to transfer digital assets to the target crypto wallet from another crypto wallet owned by the same user (or vice versa). In some aspects, all digital assets from a given crypto wallet can be transferred to another crypto wallet, and the given crypto wallet can be deleted. This consolidation process increases the balance of a crypto wallet, ensuring that it maintains a sufficient level of digital assets to function efficiently.

Aspects of the technology described herein provide a number of improvements over existing technologies. For instance, by automating the rebalancing and consolidation of crypto wallets, the system reduces the manual effort required to manage digital assets, thereby minimizing the risk of human error. Rebalancing reduces the balances of crypto wallets when they exceed a maximum threshold value, thereby mitigating the risk associated with holding large amounts of digital assets in a single wallet. This approach enhances security by distributing digital assets across multiple wallets, each with a balance below the maximum threshold. Conversely, consolidation increases the balances of crypto wallets that are low, ensuring that the wallets maintain a sufficient level of digital assets to function efficiently. Additionally, the use of a time duration threshold to detect trigger events ensures that these events are not triggered too frequently, which would be inefficient. This optimizes the timing of rebalancing and consolidation actions, leveraging the inherent security features of blockchain technology to execute transfers securely and efficiently. This approach not only enhances the security of digital assets but also optimizes their distribution across multiple crypto wallets, reducing the risk of significant losses due to hacking or other security breaches.

### Example System for Automatic Crypto Wallet Balancing

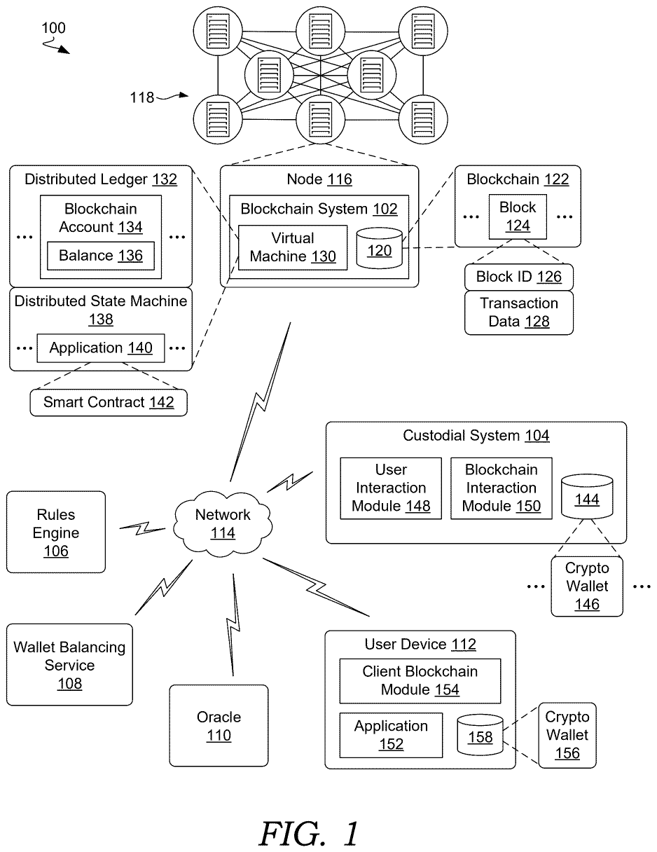

FIG. 1 is an illustration of a blockchain environment 100 in an example implementation that is operable to employ techniques described herein. The blockchain environment 100 includes a blockchain system 102, a custodial system 104, a rules engine 106, a wallet balancing service 108, an oracle 110, and a user device 112 that are communicatively coupled via a network 114. While the blockchain environment 100 illustrates a configuration showing separate components in a networked environment, it should be understood that other configurations can be employed in which aspects of the various components are combined. By way of example and not limitation, in various aspects, the rules engine 106 can be provided by the wallet balancing service 108, and the wallet balancing service 108 can be provided by the custodial system 104 or the oracle 110. In further aspects, features of some components shown as off-chain in FIG. 1, such as the rules engine 106 and the wallet balancing service 108, can be provided on-chain by integrating the aspects into the blockchain system 102.

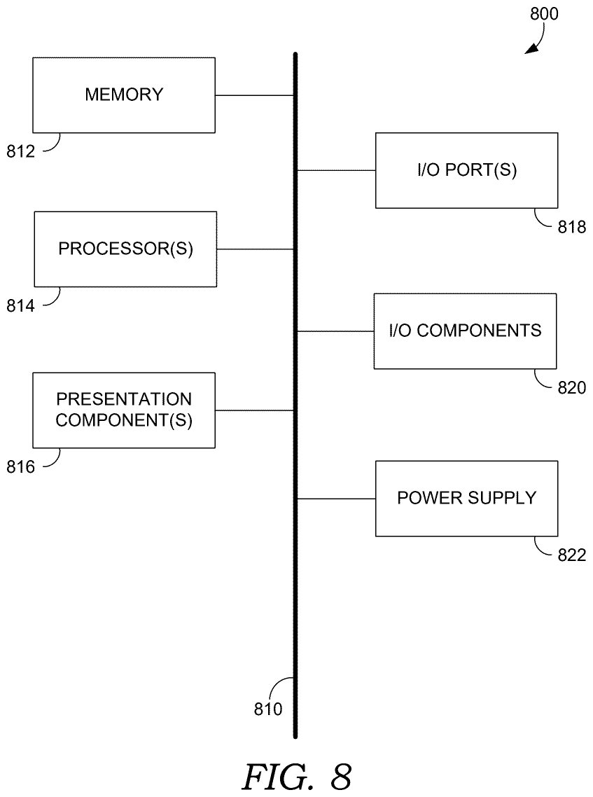

Computing devices that implement the blockchain environment 100 are configurable in a variety of ways. A computing device, for instance, is configurable as a desktop computer, a laptop computer, a mobile device (e.g., assuming a handheld configuration such as a tablet or mobile phone), IoT device, a wearable device, AR/VR device, a server, and so forth. Thus, a computing device ranges from full resource devices with substantial memory and processor resources to low-resource devices with limited memory and/or processing resources. By way of example, each computing can comprise a device such as the computing device 800 of FIG. 8, discussed below. Additionally, although in instances in the following discussion reference is made to a computing device in the singular, a computing device is also representative of a plurality of different devices, such as multiple servers of a server farm utilized to perform operations in a distributed, networked environment.

The blockchain system 102 is implemented by a plurality of nodes 116. Nodes 116 are a runtime implemented using processing, memory, and network resources of respective computing devices 118 that operate as the infrastructure providing a blockchain 122. As part of this, the nodes 116 store, communicate, process, and manage data that makes up the blockchain 122. Nodes 116 are interconnected as illustrated in FIG. 1 to exchange data via the network 114, e.g., as a peer-to-peer network in a distributed and decentralized manner.

The blockchain 122 is formed using a plurality of blocks 124, illustrated in FIG. 1 as including respective block identifiers (IDs) 126 and transaction data 128. Transaction data 128 of the blocks 124 includes, for instance, batches of validated transactions that are hashed and encoded. Each block 124 includes a cryptographic hash of a prior block 124 in the blockchain 122, thereby linking the blocks 124 to each other to form the blockchain 122. As a result, the blocks 124 cannot be altered retroactively without altering each subsequent block 124 in the blockchain 122 and in this way protects against attacks by malicious parties.

In order to generate the blocks 124 for addition to the blockchain 122, a node 116 is implemented as a “miner” to add a block of transactions to the blockchain 122. The other nodes 116 of the blockchain system 102 check if the block of transactions is valid, and based on this, determine whether to accept or reject this data. If valid, the block of transactions is stored as transaction data 128 along with a block ID 126 for a respective block 124, e.g., is stored “at the end” or “at the top” of the blockchain 122 along with a hash of a previous block in the chain. The nodes 116 broadcast this transaction history via the network 114 for sharing with other nodes 116. This acts to synchronize the blocks 124 of the blockchain 122 across the distributed architecture of the blockchain system 102. Other types of nodes 116 can also be included as part of the blockchain system 102. In one such example, full nodes are nodes that store an entirety of the blockchain 122, e.g., locally in computer-readable storage media of a respective storage device 120. Other types of nodes are also employed to implement additional functionality, for instance, to govern voting events, execution of protocol operations, rules enforcement, and so forth.

In some aspects, the blockchain system 102 implements a virtual machine 130 that is representative of a diverse range of functionality made possible by leveraging the blockchain 122. In a first such example, the virtual machine 130 implements a distributed ledger 132 of blockchain accounts 134 and associated balances 136 of those blockchain accounts 134. The distributed ledger 132 supports secure transfer of digital assets (e.g., tokens or coins of cryptocurrencies) between blockchain accounts 134 without management by a central authority through storage as part of the transaction data 128 of the blockchain 122. Through synchronized and distributed access supported by the blockchain 122 as described above, changes to balances 136 (e.g., a number of tokens) are visible to any entity with access to the blockchain 122.

In another example, the virtual machine 130 implements a distributed state machine 138 that supports execution of applications 140, which can reside within blocks 124 of the blockchain 122. The distributed state machine 138 is implemented along with the transaction data 128 within the blocks 124 of the blockchain 122 such that the blocks 124 describe accounts and balances as described above for the distributed ledger 132. The transaction data 128 also supports a machine state, which can change from block to block of the blockchain 122. In one example, an application 140 is executable as part of a “Turing-complete” decentralized virtual machine that is distributed across the nodes 116 of the blockchain system 102. As Turing-complete, the application 140 is computationally universal to perform computing device operations, e.g., logic or computing functions. Thus, the application 140 is executable by a processing system of a computing device as software that is storable in a computer-readable storage media of the nodes 116 to perform a variety of operations.

An example of an application 140 that is executable as part of the distributed state machine 138 is a smart contract 142. A smart contract 142 is executable automatically and without user intervention (or with partial human interaction as inputs when desired) by the nodes 116 of the distributed state machine 138. Execution of the smart contract 142 includes obtaining data from a specified data source (e.g., devices, APIs, and so forth that are accessible via the network 114), and based on this data, initiating one or more operations based on conditions described in the smart contract 142. In one example, the smart contract 142 is a “smart account,” which is a type of blockchain account 134 that includes a balance 136 and initiates transactions based on conditions specified by the smart contract 142, e.g., to support automated escrow and other functionalities. A variety of other examples are also contemplated that support implementation of any executable operation by a computing device using software.

The custodial system 104 securely manages and maintains crypto wallets 146 on behalf of its users, e.g., in storage device 144. The custodial system 104 provides a high level of security by storing private keys in secure environments to protect against hacking and unauthorized access. The custodial system 104 maintains a number of crypto wallets 146 for users. The crypto wallets 146 store public and private cryptographic keys that are used to support interaction with the blockchain system 102, and more particularly respective blockchain accounts 134 of the blockchain system 102. Each crypto wallet 146 can be associated with one or more blockchain accounts 134 of the blockchain system 102.

A public key supports transactions to an address of a corresponding blockchain account 134 derived from the public key, which are stored as part of the blockchain 122 to memorialize the transactions as part of transaction data 128. In one example, an address of a blockchain account 134 is generated by generating a private key, e.g., using a randomization technique, deriving a corresponding public key from the private key, and deriving the address of the blockchain account 134 from the public key, e.g., as an entirety of the public key or as a shortened version of the public key. The private key is used to “unlock” transactions that are “locked” by the public key and gain access to the blockchain account 134, e.g., access to coins, tokens or other information maintained as part of the transactions.

FIG. 1 presents a configuration in which the blockchain environment 100 includes a single blockchain system 102. In this configuration, the crypto wallets 146 are referred to herein as “single-chain wallets”, since the crypto wallets 146 correspond to blockchain accounts 134 only on the blockchain system 102. However, in other configurations, the blockchain environment 100 can include one or more other blockchain systems in addition to the blockchain system 102. In such aspects, a crypto wallet 146 can be associated with one or more blockchain accounts 134 of the blockchain system 102 and one or more blockchain accounts of one or more other blockchain systems. This is referred herein to as a “multi-chain crypto wallet.” For instance, a crypto wallet 146 could be associated with an account on the Bitcoin blockchain and an account on the Ethereum blockchain.

The custodial system 104 also includes a user interaction module 148 and a blockchain interaction module 150 that are executable via a processing system of the custodial system 104. The user interaction module 148 facilitates interactions with user devices, such as the user device 112. Among other things, the user interaction module 148 provides secure access to crypto wallets 146, for instance, through login credentials, two-factor authentication, or biometric verification. This allows users to manage funds, check balances, view transaction history, and initiate deposits, withdrawals, or transfers through an interface. The blockchain interaction module 150 accesses functionality made available via the blockchain system 102. For instance, the blockchain interaction module 150 can handle the signing (e.g., using a private key) and broadcasting of transactions to the blockchain system 102.

The rules engine 106 stores rules for performing automatic crypto wallet rebalancing and consolidation. The rules can be defined, for instance, by users (in the case of personal rules), administrators of the custodial system 104, and/or other entities. The rules in the rules engine 106 include rebalancing rules to detect rebalance trigger events for transferring digital assets from a target crypto wallet 146 owned by a user to one or more recipient crypto wallets 146 owned by the same user in order to reduce the total value of the target crypto wallet 146. The rebalancing rules can also dictate an amount of digital assets to transfer when a rebalance trigger event occurs and how to select one or more recipient crypto wallets 146.

The rules in the rules engine 106 also include consolidation rules to detect consolidation trigger events for consolidating crypto wallets 146 owned by a user based on low balances. The consolidation rules can also dictate how to select crypto wallets 146 to consolidate and/or how to determine an amount of digital assets to transfer between crypto wallets 146.

Using the rules in the rules engine 106, the wallet balancing service 108 facilitates rebalancing and consolidation of crypto wallets 146 on the custodial system 104 by causing the transfer of digital assets between crypto wallets 146. The wallet balancing service 108 monitors balances of crypto wallets 146 on the custodial system 104 using rules from the rules engine 106 to detect trigger events for transferring digital assets. When a trigger event is detected for a target crypto wallet 146, the wallet balancing service 108 causes execution of a smart contract 142 on the blockchain system 102 to cause digital assets to be transferred from a blockchain account 134 associated with the target crypto wallet 146 to another blockchain account 134 associated with a recipient crypto wallet 146.

In accordance with some aspects of the technology described herein, the wallet balancing service 108 detects a rebalance trigger event when the total value (i.e., balance) of a target crypto wallet 146 exceeds a maximum threshold value for a time duration threshold (i.e., a threshold amount of time over a time period), which can be specified by the rules in the rules engine 106. In some aspects, the maximum threshold value can be manually defined (e.g., by the owner of the crypto wallet 146, an administrator of the custodial system 104, and/or another entity); while in other aspects, the maximum threshold value can be based on an external factor, such as an upper limit of insured asset value by an insurance policy. For instance, the maximum threshold value could be set at 80% of the upper limit of an insurance policy for the crypto wallet 146. The rebalancing rules use a time duration threshold to prevent frequent rebalancing that could occur without the requirement. For instance, fluctuations in the underlying value of digital assets in a crypto wallet 146 can cause the total value of the crypto wallet 146 to spike and drop quickly.

In some aspects of the technology described herein, the wallet balancing service 108 detects a consolidation trigger event when the total value (i.e., balance) of a target crypto wallet 146 is below a minimum threshold value for a time duration threshold (which could be the same as or different from the time duration threshold used for rebalancing). In some aspects, the minimum threshold value can be manually defined (e.g., by the owner of the crypto wallet 146, an administrator of the custodial system 104, and/or another entity); while in other aspects, the minimum threshold value can be based on an external factor, such as an upper limit of insured asset value by an insurance policy. For instance, the minimum threshold value could be set at 30% of the upper limit of an insurance policy for the crypto wallet 146. The consolidation rules use a threshold duration threshold to prevent frequent consolidation that could occur without the requirement, for instance, due to fluctuation of the underlying value of digital assets for a crypto wallet 146.

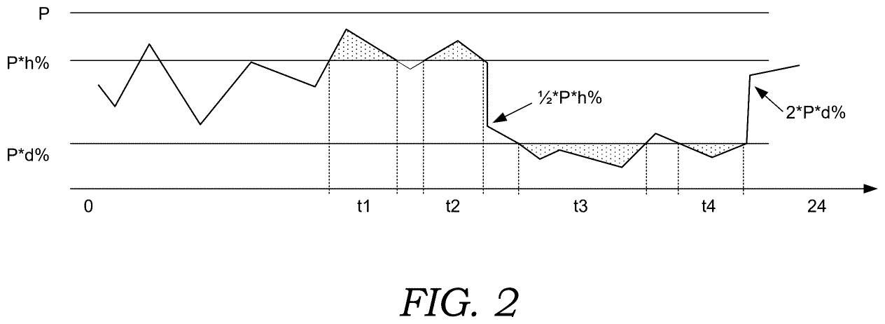

By way of example to illustrate, FIG. 2 presents a chart showing the total value of a target crypto wallet over a 24-hour time period. In FIG. 2, “P” is the upper limit of insured asset value by an insurance policy, “h” is a percentage (e.g., 80%) of P for setting the maximum threshold value used to trigger rebalancing, and “d” is a percentage (e.g., 30%) of P for setting the minimum threshold value used to trigger consolidation. Accordingly, the line labeled P*h % represents the maximum threshold value for rebalancing, and the line labeled P*d % represents the minimum threshold value for consolidation. In this example, also suppose that “s” is a percentage (e.g., 10%) for setting a time duration threshold based on a 24-hour period (i.e., the time duration threshold is 24*s %), and the same time duration threshold is used for both rebalancing and consolidation.

As shown in FIG. 2, the total value of the target crypto wallet first exceeds the maximum threshold value P*h % for a first time duration t1. Because the first time duration t1 is less than the time duration threshold 24*s%, a rebalance trigger event is not detected at that time. The total value of the target crypto wallet subsequently exceeds the maximum threshold value P*h % for a second time duration t2. Because the total amount of time (t1+t2) at that point within the 24-hour period exceeds the time duration threshold 24*s %, a rebalance trigger event is detected. Based on the rebalance trigger event, digital assets are transferred from the target crypto wallet to a recipient crypto wallet owned by the same user, as reflected in FIG. 2 by the drop in the total value of the target crypto wallet at the end of the second time duration t2. In the present example, the amount of digital assets transferred from the target crypto wallet reduces the total value of the crypto wallet to half of the maximum trigger value (½*P*h %).

FIG. 2 also provides an example of a consolidation event. In particular, the total value of the target crypto wallet first drops below the minimum threshold value P*d % for a third time duration t3. Because the third time duration t3 is less than the time duration threshold 24*s %, a consolidation trigger event is not detected at that time. The total value of the target crypto wallet subsequently falls below the minimum threshold value P*d % for a fourth time duration t4. Because the total amount of time (t3+t4) at that point within the 24-hour period exceeds the time duration threshold 24*s %, a consolidation trigger event is detected. Based on the consolidation trigger event, digital assets are transferred to the target crypto wallet from a transferor crypto wallet owned by the same user, as reflected by the increase in the total value of the target crypto wallet at the end of the fourth time duration t4. In the present example, the amount of digital assets transferred to the target crypto wallet increases the total value of the crypto wallet to twice the minimum trigger value (2*P*d %).

With reference again to FIG. 1, when the wallet balancing service 108 detects a rebalance trigger event for a target crypto wallet 146, the wallet balancing service 108 can determine the amount of digital assets to transfer from the target crypto wallet 146 and/or select the recipient crypto wallet(s) 146 to receive the digital assets from the target crypto wallet 146. The amount of digital assets to transfer can be based on a number of factors, such as the total value of the target crypto wallet 146 when the rebalance trigger event occurs and/or the total value of each recipient crypto wallet(s) 146 when the rebalance trigger event occurs. In various scenarios, the wallet balancing service 108 can select to transfer digital assets to one or more existing crypto wallets 146 owned by the user, one or more newly-generated crypto wallets 146 (owned by the user), or any combination thereof. The selection of recipient crypto wallet(s) 146 can be based on a number of factors, such as whether there are any existing crypto wallets 146 owned by the user when the rebalance trigger event occurs, the total value of each existing crypto wallet 146 owned by the user when the rebalance trigger event occurs, the total value of the target crypto wallet 146 when the rebalance trigger event occurs, and/or the amount of digital assets to be transferred from the target crypto wallet 146.

When the wallet balancing service 108 detects a consolidation trigger event for a target crypto wallet 146, the wallet balancing service 108 can determine the amount of digital assets to transfer to the target crypto wallet 146 and/or select the transferor crypto wallet(s) 146 to provide the digital assets to the target crypto wallet 146. The amount of digital assets to transfer can be based on a number of factors, such as the total value of the target crypto wallet 146 when the consolidation trigger event occurs and/or the total value of each transferor crypto wallet(s) 146 when the consolidation trigger event occurs. In various scenarios, the wallet balancing service 108 can select recipient crypto wallet(s) 146 from which to transfer digital assets to the target crypto wallet 146 based on a number of factors, such as the total value of each existing crypto wallet 146 owned by the user when the consolidation trigger event occurs, the total value of the target crypto wallet 146 when the rebalance trigger event occurs, and/or the amount of digital assets to be transferred from the target crypto wallet 146. While the above describes transferring digital assets to the target crypto wallet 146 from another crypto wallet 146 in response to a consolidation event, in other aspects, digital assets can be transferred from the target crypto wallet 146 to another crypto wallet 146.

As noted above, while FIG. 1 shows a single blockchain system 102, the blockchain environment 100 can include additional blockchain systems not shown, and the crypto wallets 146 at the custodial system 104 can be multi-chain crypto wallets with digital assets from blockchain accounts on multiple blockchain systems. In such configurations, when a rebalance trigger event is detected for a target crypto wallet 146, the wallet balancing service 108 can determine a total amount of digital assets to transfer from the target crypto wallet 146 and a recipient crypto wallet 146 (which could be an existing crypto wallet 146 owned by the user or a newly generated crypto wallet 146). Additionally, the wallet balancing service 108 can select one or more blockchain accounts in the target crypto wallet 146 from which to transfer digital assets, one or more blockchain accounts in the recipient crypto wallet 146 to receive digital assets, and an amount of digital assets to transfer between blockchain accounts on each blockchain system. This can be based on factors, such as the total value of each blockchain account in the target crypto wallet 146, the total value of each blockchain account in the recipient crypto wallet 146, and/or a total amount of digital assets to transfer for the target crypto wallet 146. Aspects of each blockchain system, such as transaction fees, could also be taken into account.

In the case of a consolidation trigger event for multi-chain crypto wallets, the wallet balancing service 108 can determine a total amount of digital assets to transfer to the target crypto wallet 146 and a transferor crypto wallet 146. Additionally, the wallet balancing service can select one or more blockchain accounts in the target crypto wallet 146 to receive digital assets, one or more blockchain accounts in the transferor crypto wallet 146 from which to transfer digital assets, and an amount of digital assets to transfer between blockchain accounts on each blockchain system. This can be based on factors, such as the total value of each blockchain account in the target crypto wallet 146, the total value of each blockchain account in the transferor crypto wallet 146, and/or a total amount of digital assets to transfer for the target crypto wallet 146. Aspects of each blockchain system, such as transaction fees, could also be taken into account.

When a rebalancing trigger event or a consolidation trigger event is detected, code of a smart contract 142 on the blockchain system 102 is executed in order to transfer digital assets between blockchain accounts 134. The smart contract 142 includes terms directly written into the code, such that the smart contract 142 automatically enforces the rules and conditions set by those terms. For instance, the smart contract 142 can validate the transaction by verifying, among other things, whether the blockchain accounts 134 involved in the transaction are owned by the same user. Once the transaction is validated, transaction data 128 for the transaction (including the sender blockchain account 134, the recipient blockchain account 134, and the digital assets being transferred, are written to a new) is written to a new block 124, and the new block 124 is added to the blockchain 122.

The oracle 110 is a service or mechanism that connects blockchain systems, such as the blockchain system 102, and off-chain systems and services. While FIG. 1 includes only a single oracle 110, it should be understood that the blockchain environment 100 can include any number of oracles. Among other things, the oracle 110 can fetch, verify, and relay external data to/from components of the blockchain environment 100, such as the blockchain system 102, the custodial system 104, and the wallet balancing service 108. This enables transferring information between on-chain and off-chain environments, for instance, enabling smart contracts 142 on the blockchain system 102 to execute based on off-chain inputs and outputs. For example, an oracle can provide a smart contract 142 on the blockchain system 102 with data from the custodial system 104 about asset holdings or transaction confirmations, enabling the smart contract 142 to execute based on this off-chain information. The oracle 110 can be centralized, relying on a single trusted source, or decentralized, using multiple sources and consensus mechanisms to enhance data accuracy and security.

The user device 112 is a computing device of a user that owns one or more crypto wallets 146 on the custodial system 104. The user device 112 includes an application 152 for interacting with the custodial system 104. The application 152 can be, for instance, a web browser or a dedicated application for providing functions, such as those described herein. The application 152 can interface with the user interaction module 148 of the custodial system 104 to provide secure access to crypto wallets 146 owned by the user (e.g., through login credentials, two-factor authentication, or biometric verification) to allow the user to manage funds, check balances, view transaction history, and initiate deposits, withdrawals, or transfers.

In some aspects, the user device 112 is configured to interact with the blockchain system 102 directly. For instance, the user device 112 can include a client blockchain module 154 that accesses functionality made available via the blockchain system 102. For instance, the client blockchain module 154 can handle the signing (e.g., using a private key) and broadcasting of transactions to the blockchain system 102. To enable direct interaction with the blockchain system 102, the user device 112 can include a crypto wallet 156, e.g., in local storage device 158, that stores public and private cryptographic keys that are used to support interaction with the blockchain system 102, and more particularly respective blockchain accounts 134 of the blockchain system 102. In some aspects, the crypto wallet 156 on the user device 112 and a crypto wallet 146 owned by the user on the custodial system 104 can store cryptographic keys for the same blockchain account 134. In some configurations, the cryptographic keys for a blockchain account 134 are the same in both the crypto wallet 156 and the crypto wallet 146. In other configurations, the cryptographic keys for a blockchain account 134 are different in the crypto wallet 156 and the crypto wallet 146. For instance, a blockchain account 134 could be associated with a public/private key pair for the custodian (i.e., custodial keys), as well as a different public/private key pair for the user (i.e., user keys).

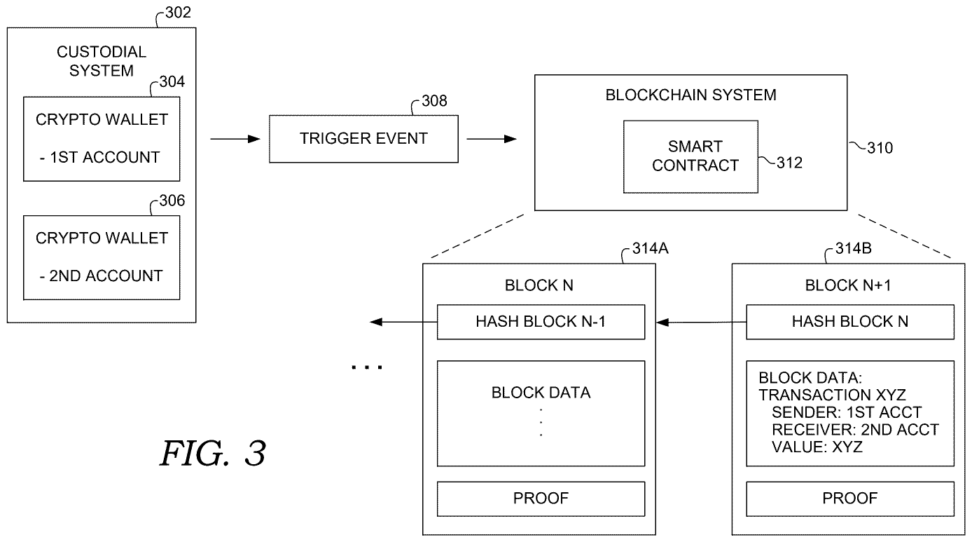

With reference next to FIG. 3, a block diagram is provided illustrating an example of rebalancing a single-chain crypto wallet. In the present example, a user owns crypto wallets at a custodial system 302, including crypto wallet 304 and crypto wallet 306. The crypto wallet 304 is associated with a first account on the blockchain system 310. The crypto wallet 304 can store the cryptographic keys for the first account, and the total value of the crypto wallet 304 includes the value of the digital assets in the first account. The crypto wallet 306 is associated with a second account on the blockchain system 310. The crypto wallet 306 can store the cryptographic keys for the second account, and the total value of the crypto wallet 306 includes the value of the digital assets in the second account. While FIG. 3 shows only a single account for each of the crypto wallets 304 and 306, it should be understood that the crypto wallets 304 and 306 can each include multiple accounts on the blockchain system 310.

A trigger event 308 is detected based on the total value of the crypto wallet 304 exceeding a threshold value for a time duration threshold. In response to the trigger event 308, a determination is made to move digital assets from the crypto wallet 304 (i.e., the target crypto wallet) to the crypto wallet 306 (i.e., the recipient crypto wallet). To do so, a smart contract 312 on the blockchain system 310 is executed to transfer digital assets from the first account in the crypto wallet 304 to the second account in the crypto wallet 306. In particular, execution of the smart contract 312 causes a new block 314B to be generated. The new block 314B includes block data that identifies a transaction transferring a specified value of digital assets from the first account to the second account. The transaction is signed using the private key for the first account (e.g., a custodial private key in the crypto wallet 304). The new block 314B also includes a hash of the previous block 314A in the blockchain (which in turn includes a hash of a block before that block 314A in the blockchain) and proof data. The new block 314B is then appended to the previous block 314A in the blockchain.

While FIG. 3 illustrates an example in which digital assets are transferred from a target crypto wallet to a single existing crypto wallet, in other instances, digital assets could be transferred from a crypto wallet to one or more existing crypto wallets owned by the user, one or more new crypto wallets generated in response to the trigger event, or any combination thereof. This could be based on, for instance, whether the user owns any other existing crypto wallets for accounts on the blockchain, the total value of any other existing crypto wallets owned by the user, and/or the value of digital assets to be transferred.

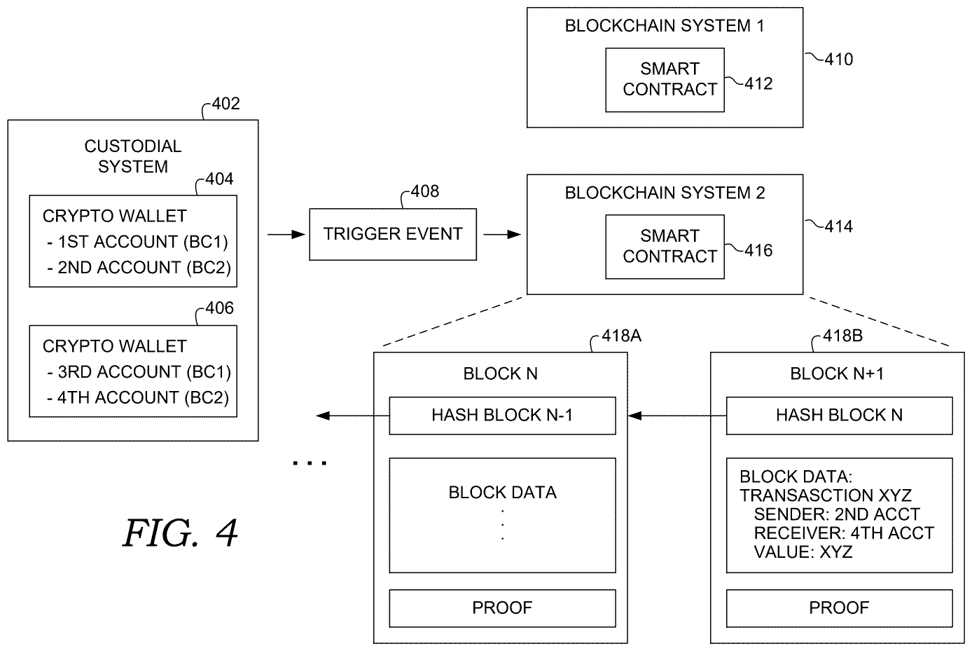

FIG. 4 is a block diagram illustrating an example of rebalancing a multi-chain crypto wallet. In the example of FIG. 4, a user owns crypto wallets at a custodial system 402, including crypto wallet 404 and crypto wallet 406. The crypto wallet 404 is associated with a first account on a first blockchain system 410 and a second account on a second blockchain system 414. The crypto wallet 404 can store the cryptographic keys for the first account and the second account, and the total value of the crypto wallet 404 includes the value of the digital assets in the first account and the second account. The crypto wallet 406 is associated with a third account on the blockchain system 410 and a fourth account on the second blockchain system 414. The crypto wallet 406 can store the cryptographic keys for the third account and the fourth account, and the total value of the crypto wallet 406 includes the value of the digital assets in the third account and the fourth account. While FIG. 4 shows only two accounts for each of the crypto wallets 404 and 406 and only two blockchain system 410 and 414, it should be understood that the crypto wallets 404 and 406 can each include any number of accounts on the blockchain system 410, the blockchain system 414, and/or one or more other blockchain systems not shown in FIG. 4.

A trigger event 408 is detected based on the total value of the crypto wallet 404 exceeding a threshold value for a time duration threshold. In response to the trigger event 408, a determination is made to move digital assets on the blockchain system 414 from the crypto wallet 404 (i.e., the target crypto wallet) to the crypto wallet 406 (i.e., the recipient crypto wallet). To do so, a smart contract 416 on the blockchain system 414 is executed to transfer digital assets from the second account in the crypto wallet 404 to the fourth account in the crypto wallet 406. In particular, execution of the smart contract 416 causes a new block 418B to be generated. The new block 418B includes block data that identifies a transaction transferring a specified value of digital assets from the second account to the fourth account. The transaction is signed using the private key for the second account (e.g., a custodial private key in the crypto wallet 404). The new block 418B also includes a hash of the previous block 418A in the blockchain (which in turn includes a hash of a block before that block 418A in the blockchain) and proof data. The new block 418B is then appended to the previous block 418A in the blockchain.

While FIG. 4 illustrates an example in which digital assets are transferred from a target crypto wallet to a single existing crypto wallet, in other instances, digital assets could be transferred from a crypto wallet to one or more existing crypto wallets owned by the user, one or more new crypto wallets generated in response to the trigger event, or any combination thereof. This could be based on, for instance, whether the user owns any other existing crypto wallets for accounts on the blockchains, the total value of any other existing crypto wallets owned by the user, and/or the value of digital assets to be transferred.

Additionally, while FIG. 4 illustrates an example in which digital assets are transferred between accounts on only one blockchain, in other instances, digital assets can be transferred between accounts on multiple blockchains in response to a trigger event. For instance, in the context of FIG. 4, in addition to transferring digital assets from the second account to the fourth account on the blockchain system 414 (via execution of the smart contract 416 as discussed above), digital assets could also be transferred from the first account to the third account on the blockchain system 410 (via execution of the smart contract 412) in response to the same trigger event. The determination of which digital assets to transfer could be based on, for instance, the value of digital assets in each of the first account and the second account in the crypto wallet 404, the value of the digital assets in each of the third account and fourth account in the crypto wallet 406, and/or the value of digital assets to be transferred from the crypto wallet 404.

### Example Methods for Automatic Crypto Wallet Balancing

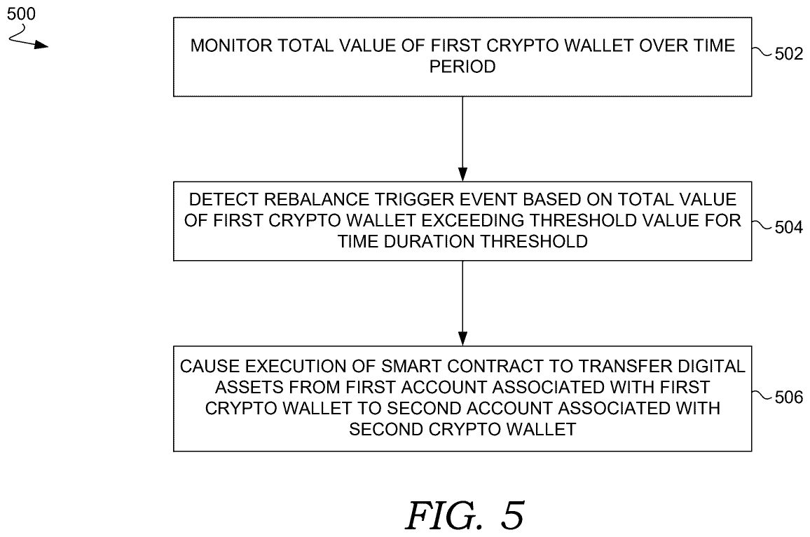

With reference now to FIG. 5, a flow diagram is provided that illustrates a method 500 for automatic crypto wallet rebalancing in response to a rebalance trigger event. The method 500 can be performed, for instance, by the wallet balancing service 108 of FIG. 1. Each block of the method 500 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 502, the total value of a first crypto wallet (i.e., a target crypto wallet) owned by a user is monitored over a time period. The first crypto wallet could be a single-chain wallet or a multi-chain wallet. In some instance, monitoring the total value of the first crypto wallet includes obtaining (e.g., from an oracle) information regarding the underlying value of a digital asset (e.g., Bitcoin) on one or more blockchain systems in order to determine the total value of the first crypto wallet over the time period. Because the underlying value of a digital asset fluctuates over time, the total value of the first crypto wallet will fluctuate even in the absence of any transactions.

A rebalance trigger event is detected at block 504 based on the total value of the first crypto wallet exceeding a threshold value for a time duration threshold (i.e., a threshold amount of time during the time period). In response to detection of the rebalance trigger event, a smart contract on a blockchain system is executed, as shown at block 506. The smart contract execution causes the transfer of digital assets from a first blockchain account associated with the first crypto wallet to a second blockchain account associated with a second crypto wallet that is also owned by the user. More particularly, execution of the code of the smart contract causes the blockchain system to generate a transaction block with transaction data transferring digital assets from the first blockchain account to the second blockchain account and to add the transaction block to the blockchain. The second crypto wallet and associated second blockchain account can be existing at the time of the rebalance trigger event or newly generated in response to the rebalance trigger event.

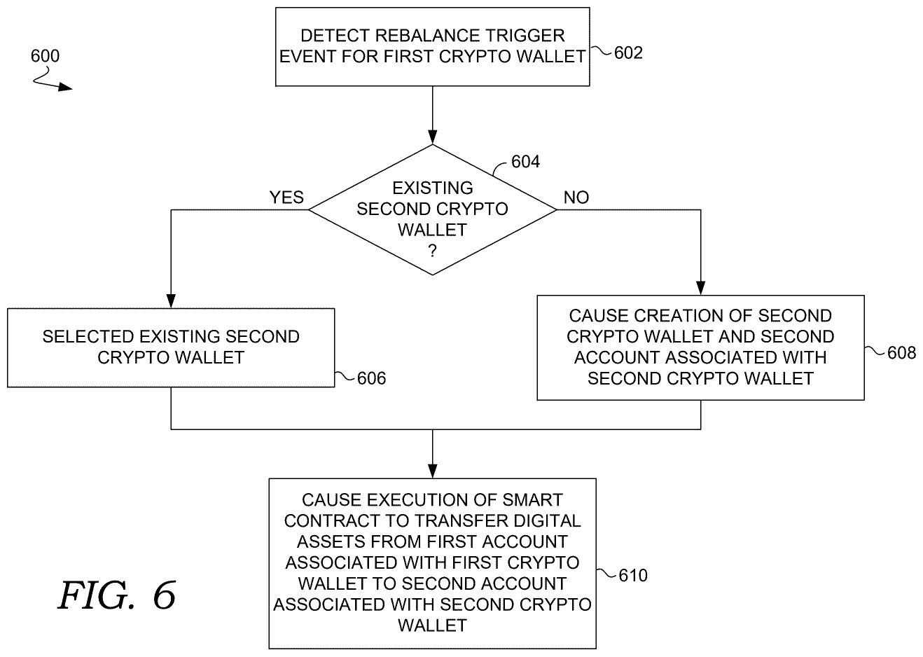

Turning next to FIG. 6, a flow diagram is provided that illustrates a method 600 for determining whether to use an existing crypto wallet or to generate a new crypto wallet for transferring digital assets in response to detecting a rebalance trigger event. The method 600 can be performed, for instance, by the wallet balancing service 108 of FIG. 1. As shown at block 602, a rebalance trigger event is detected for a first crypto wallet owned by a user. The rebalance trigger event could be detected, for instance, by monitoring the total value of the first crypto wallet over a time period and determining the total value of the first crypto wallet has exceeded a threshold value for a time duration threshold.

In response to detecting the rebalance trigger event, a determination is made at block 604 regarding whether there is an another existing crypto wallet owned by the user that could be used to receive digital assets from the first crypto wallet. In some instances, the user may not own any other crypto wallets. In other instances, when there are one or more other existing crypto wallets owned by the user, the determination made at block 604 can involve assessing the total value of the one or more other existing crypto wallets to determine if transferring digital assets from the first digital wallet to the other existing crypto wallet(s) will cause the total value of the other existing crypto wallet(s) to exceed a threshold value. This could be the same threshold value used to determine the rebalance trigger event or a lower threshold value.

If an existing second crypto wallet is identified for use, the existing second crypto wallet is selected as a recipient crypto wallet, as shown at block 606. Alternatively, if another existing crypto wallet is not identified for use, a new second crypto wallet and associated second blockchain account are generated, as shown at block 608. In either case, a smart contract on a blockchain system is executed, as shown at block 610, which causes the transfer of digital assets from a first blockchain account associated with the first crypto wallet to a second blockchain account associated with the second crypto wallet (i.e., existing or newly created). More particularly, execution of the code of the smart contract causes the blockchain system to generate a transaction block with transaction data transferring digital assets from the first blockchain account to the second blockchain account and to add the transaction block to the blockchain.

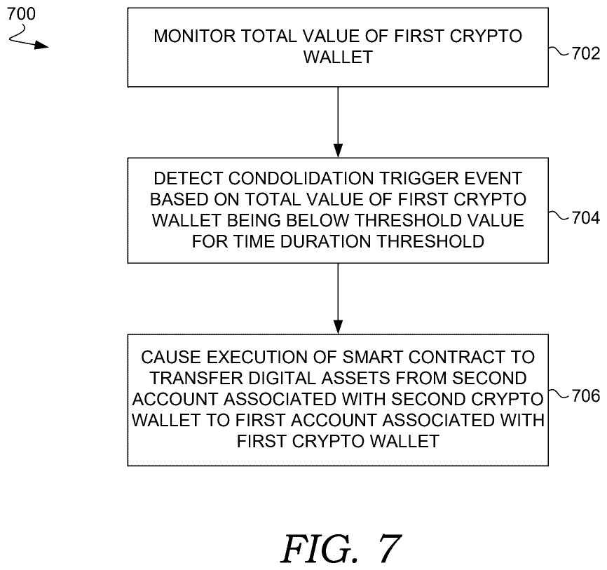

With reference now to FIG. 7, a flow diagram is provided that illustrates a method 700 for automatic crypto wallet consolidation in response to a consolidation trigger event. The method 700 can be performed, for instance, by the wallet balancing service 108 of FIG. 1. As shown at block 702, the total value of a first crypto wallet owned by a user (i.e., a target crypto wallet) is monitored over time period. A consolidation trigger event is detected at block 704 based on the total value of the first crypto wallet being below a threshold value for a time duration threshold (i.e., a threshold amount of time during the time period). In some cases, the consolidation trigger event can also involve determining the threshold value of one or more other crypto wallets owned by the user are also below the threshold value.

In response to detection of the consolidation trigger event, a smart contract on a blockchain is executed, as shown at block 706. The smart contract causes the transfer of digital assets from a second account associated with a second crypto wallet owned by the same user to a first account associated with the first crypto wallet. More particularly, execution of the code of the smart contract causes the blockchain system to generate a transaction block with transaction data transferring digital assets from the second blockchain account to the first blockchain account and to add the transaction block to the blockchain. The second account can be selected for transferring the digital assets to the first account, for instance, based on a total value of the second account and the value of the digital assets to be transferred.

In some cases, consolidation can involve transferring only a portion of the digital assets from one crypto wallet to another crypto wallet. In other cases, consolidation can involve transferring all digital assets from one crypto wallet to another crypto wallet. When all digital assets are transferred from a crypto wallet, that crypto wallet can be deleted. However, in some cases, the crypto wallet is not deleted. This could allow for the crypto wallet to be used to receive digital assets from another crypto wallet of the user if a rebalance trigger event is detected in the future indicating the total value of a crypto wallet owned by the user has exceeded a threshold value for a threshold time duration. This prevents the need to create a new crypto wallet at that time if the previously-emptied crypto wallet had been deleted.

### Exemplary Operating Environment

Having described implementations of the present disclosure, an exemplary operating environment in which embodiments of the present technology may be implemented is described below in order to provide a general context for various aspects of the present disclosure. Referring initially to FIG. 8 in particular, an exemplary operating environment for implementing embodiments of the present technology is shown and designated generally as computing device 800. Computing device 800 is but one example of a suitable computing environment and is not intended to suggest any limitation as to the scope of use or functionality of the technology. Neither should the computing device 800 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 8 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc. The I/O components 820 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 800. The computing device 800 may be equipped with depth cameras, such as, stereoscopic camera systems, infrared camera systems, RGB camera systems, and combinations of these for gesture detection and recognition. Additionally, the computing device 800 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

1. One or more computer storage media storing computer-useable instructions that, when used by one or more computing devices of a custodial system, cause the one or more computing devices to perform operations, the operations comprising:
monitoring, by at least one of the one or more computing devices of the custodial system, a total value of a first crypto wallet over a time period, the first crypto wallet owned by a first user and associated with a first blockchain account on a first blockchain;
detecting, by at least one of the one or more computing devices of the custodial system, a rebalance trigger event based on the total value of the first crypto wallet exceeding a maximum threshold value for a cumulative threshold amount of time during the time period, wherein the cumulative threshold amount of time comprises multiple non-consecutive time intervals during the time period; and
responsive to the rebalance trigger event, causing, by at least one of the one or more computing devices of the custodial system, execution of code of a smart contract on the first blockchain, execution of the code of the smart contract causing:
generation of a transaction block transferring one or more digital assets from the first blockchain account to a second blockchain account associated with a second crypto wallet owned by the first user, and addition of the transaction block to the first blockchain.

2. The one or more computer storage media of claim 1, wherein the first blockchain account is associated with a first private key of a custodian entity and a first private key of the first user, and the second blockchain account is associated with a second private key of the custodian entity and a second private key of the first user.

3. The one or more computer storage media of claim 1, wherein the second crypto wallet is existing when the rebalance trigger event is detected, and wherein the operations further comprise:
determining a total value of the second crypto wallet with the one or more digital assets from the first blockchain account will not exceed the maximum threshold value or a second threshold value.

4. The one or more computer storage media of claim 1, wherein the operations further comprise:
determining the one or more digital assets to be transferred from the first blockchain account to the second blockchain account based on one or more selected from the following: the total value of the first crypto wallet at a time of detecting the rebalance trigger event, a total value of the one or more digital assets, and a total value of the second crypto wallet at the time of detecting the rebalance trigger event.

5. The one or more computer storage media of claim 1, wherein the operations further comprise:
causing creation of the second crypto wallet and the second blockchain account in response to the rebalance trigger event.

6. The one or more computer storage media of claim 5, wherein the second crypto wallet and the second blockchain account are created in response to determining absence of any other existing crypto wallet owned by the first user or determining absence of an other existing crypto wallet owned by the first user for which a total value of the other existing crypto wallet with the one or more digital assets from the first blockchain account will not exceed the maximum threshold value or a second threshold value.

7. The one or more computer storage media of claim 1, wherein the first crypto wallet is associated with a third blockchain account on a second blockchain and the second crypto wallet is associated with a fourth blockchain account on the second blockchain; and wherein the operations further comprise:
determining to transfer the one or more digital assets from the first blockchain account to the second blockchain account based on one or more selected from the following: a total value of the first blockchain account, a total value of the second blockchain account, a total value of the third blockchain account, a total value of the fourth blockchain account, and a total value of the one or more digital assets.

8. The one or more computer storage media of claim 1, wherein the first crypto wallet is associated with a third blockchain account on a second blockchain and the second crypto wallet is associated with a fourth blockchain account on the second blockchain; and wherein the operations further comprise:
responsive to the rebalance trigger event, causing execution of code of a second smart contract on the second blockchain, execution of the code of the second smart contract causing: generation of a second transaction block transferring one or more digital assets from the third blockchain account to the fourth blockchain account, and addition of the second transaction block to the second blockchain.

9. The one or more computer storage media of claim 1, wherein the smart contract prevents transferring any digital assets of the first blockchain account to a blockchain account not owned by the first user.

10. The one or more computer storage media of claim 1, wherein the operations further comprise:
detecting a consolidation trigger event based on the total value of the first crypto wallet being below a minimum threshold value for a second threshold amount of time during a second time period; and
responsive to the consolidation trigger event, causing execution of code of the smart contract on the first blockchain, execution of the code of the smart contract comprising: generation of a second transaction block transferring one or more further digital assets from the second blockchain account or a third blockchain account to the first blockchain account, and addition of the second transaction block to the first blockchain.

11. The one or more computer storage media of claim 10, wherein the second transaction block transfers all digital assets from the second blockchain account and the second crypto wallet is deleted.

12. A computer-implemented method comprising:
monitoring, by at least one of one or more servers of a custodial system, a total value of a first crypto wallet over a time period, the first crypto wallet owned by a first user and associated with a first blockchain account on a first blockchain and a second blockchain account on a second blockchain;
detecting, by at least one of the one or more servers of the custodial system, a rebalance trigger event based on the total value of the first crypto wallet exceeding a maximum threshold value for a cumulative threshold amount of time during the time period, wherein the cumulative threshold amount of time comprises multiple non-consecutive time intervals;
determining, by at least one of the one or more servers of the custodial system, one or more digital assets to be transferred from the first crypto wallet and a second crypto wallet to receive the one or more digital assets, the second crypto wallet owned by the first user and associated with a third blockchain account on the first blockchain and a fourth blockchain account on the second blockchain; and
causing, by at least one of the one or more servers of the custodial system, execution of code of a smart contract on the first blockchain, execution of the code of the smart contract causing: generation of a transaction block transferring at least a portion of the one or more digital assets from the first blockchain account to the third blockchain account, and addition of the transaction block to the first blockchain.

13. The computer-implemented method of claim 12, wherein the one or more digital assets to be transferred from the first crypto wallet are determined based on one or more selected from the following: the total value of the first crypto wallet at a time of detecting the rebalance trigger event, a total value of the one or more digital assets, and a total value of the second crypto wallet at the time of detecting the rebalance trigger event.

14. The computer-implemented method of claim 12, wherein the second crypto wallet is selected from a plurality of existing crypto wallets owned by the first user based on one or more selected from the following: a total value of the second crypto wallet at the time of detecting the rebalance trigger event, and the total value of the one or more digital assets.

15. The computer-implemented method of claim 12, wherein the transaction block transfers a first portion of the one or more digital assets from the first blockchain account to the third blockchain account, and wherein execution of the code of the smart contract further causes: generation of a second transaction block transferring a second portion of the one or more digital assets from the second blockchain account to the fourth blockchain account, and addition of the second transaction block to the second blockchain.

16. The computer-implemented method of claim 15, wherein the first portion of the one or more digital assets and the second portion of the one or more digital assets are determined based on one or more selected from the following: a total value of the first account, a total value of the second account, a total value of the third account, and a total value of the fourth account.

17. A custodial system having one or more servers comprising:
one or more processors; and
one or more computer storage media storing computer-useable instructions that, when used by the one or more processors, causes the one or more servers to perform operations comprising:
monitoring, by at least one of the one or more servers of the custodial system, a total value of a first crypto wallet over a time period, the first crypto wallet owned by a first user and associated with a first blockchain account on a first blockchain;
detecting, by at least one of the one or more servers of the custodial system, a consolidation trigger event based on the total value of the first crypto wallet being below a minimum threshold value for a cumulative threshold amount of time during the time period, wherein the cumulative threshold amount of time comprises multiple non-consecutive time intervals; and
responsive to the consolidation trigger event, causing, by at least one of the one or more servers of the custodial system, execution of code of a smart contract on the first blockchain, execution of the code of the smart contract causing: generation of a transaction block transferring one or more digital assets to the first blockchain account from a second blockchain account associated with a second crypto wallet owned by the first user, and addition of the transaction block to the first blockchain.

18. The custodial system of claim 17, wherein the second account is selected for transferring the one or more digital assets based on a total value of the second account and a value of the one or more digital assets.

19. The custodial system of claim 17, wherein the consolidation trigger event is detected also based on a total value of the second crypto wallet.

20. The custodial system of claim 17, wherein the transaction block transfers all digital assets from the second blockchain account and the second crypto wallet is deleted.
